(19) United States
(12) Patent Application Publication
(10) Pub. No.: US 2006/0178931 A1
(43) Pub. Date: Aug. 10, 2006

(54) Controling customer demand to match capicity

(75) Inventor: Stephen Taylor Horn, White Stone, VA (US)

Correspondence Address: Stephen Taylor Horn, 1661 James Wharf Road, White Stone, VA, 22578, US

(73) Assignee: Summerbrook Media Incorporated

(21) Appl. No.: 11/051,872

(22) Filed: Feb. 5, 2005

(51) Int. Cl. G06Q 30/00; G06F 9/44

(52) U.S. Cl. 705/14; 705/7

(57) ABSTRACT

The method of optimizing the productive capacity or profit incentive of a business by allowing the change of advertising of mobile signs on roadways where potential customers are traveling. The signs can be changed to influence the present demand of the consumer for a particular product or location to obtain a service or product as is deemed necessary by the productive capacity of the particular business.

### CROSS-REFERENCE TO RELATED APPLICATIONS

Horn et al applicant of this date titled “Mobile Information Display”

Horn applicant of this date titled “Advertisement Comprehension in Mobile Media”

Horn applicant of this date titled “Sales Method for Mobile Media”

### FEDERALLY SPONSORED RESEARCH

None

### SEQUENCE LISTING

None

### 1. FIELD OF THE INVENTION

This invention applies to mobile sign advertising that is updated to reflect the needs of the advertiser with regard to his profitable productive capacity or profit incentive. Specifically identified are trucks with GPS enabled signs on the rear of them that are updated through a cell phone link and provide advertising for fast food restaurants along the roadways to motorists allowing fast food restaurants to profitably control customer demand.

### 2. DESCRIPTION OF THE PRIOR ART

There is a limited discussion of mobile advertising in the prior art but none concerning the direct communication control of potential customers traveling toward a business.

### 3. SUMMARY OF THE INVENTION

Typically a businesses has a limit to its productive capacity and to sell beyond that productive capacity is more than a waste of marketing; it is also damaging to creditability of a business whose customer base expects fulfillment of its needs. Often a company will have alternative productive capacity at another location such as a branch store or a alternative product such as a hotdog instead of a burger, whose materials or personal are under utilized and can be substituted for a product that cannot otherwise be produced. Sometimes productive capacity should be thought of as profitable productive capacity as in where resources in a particular area are strained beyond their profitability. This can happen when key personal are over worked or key equipment is overdue for maintenance and a threat to the future profitability to the business arises from this stress.

A good example of this is a fast food restaurant that offers a limited variety of food and where the productive capacity of one type of food is stressed by customer demand on a particular day. There could be a limited capacity or materials for bacon burgers while the normally popular barbeque is underutilized. Or one fast food franchise has two bus load of school band members at the rush lunch hour while another allied franchise only one mile away is relatively vacant. In both situations the productive capacity of the business for that moment is met and their customer base is likely to be disappointed and look for food service elsewhere. Of those that go elsewhere a certain proportion of these customers are lost for good. The present invention seeks to remedy this by influencing the customer demand as the customer approaches in the direction of the business.

The present invention uses using directly accessible advertising that can direct an anticipated consumer to an alternative product or location of an alternative facility. Such advertising could be on the rear of a tractor trailer truck on a sign that could be changeable by the business itself in near real time through use of a password or key of some kind. By anticipating consumer demand for a product by the demographics, particular location, direction of travel and time of day of motorists on a highway, advertising can shape and direct that demand in efficient ways for a business. The advertising must be immediate and as changeable as the consumer need is changeable during business operation. When, for example, avertising for a automatic car wash there should be adequate capacity for cars at that time or the advertising is wasted and should be changed to direct motorists to perhaps another allied business such as for example an oil change facility. Present advertising methods often advertise when it is not needed and relies on an averaging system to be effective. It is somewhat effective most of the time is the attitude. The quickness of change and immediacy of message of the particular advertising should meet the demand cycle of the consumer. The demand cycle time for a particular type of food desired by a consumer is shorter than the demand cycle for a different model of car for instance. And once the consumer has eaten they will not want food for some hours while once a consumer has purchased a car they will not want another car for probably many months. The same is with a car wash; it has a particular demand cycle time before the car is dirty again. The demand cycle is the mean amount of time of a typical consumer driven by need of a product. Often the demand cycle is short and the advertising presented to a consumer must be changeable to accommodate this cycle or the customer is lost. This can be done with a mobile sign traveling along the direction of travel of customers that can be changed by the particular business within the demand cycle time of the customer with regard to the product being sold. A means is needed to determine the location and direction of the sign and a means to communicate with it. Such means could be a compass or by sequencing GPS signals and establishing vectors of travel. The sign is on a vehicle such as a truck and naturally follows the ebb and flow of traffic and is subject to the detours and changes in habits of motorists over time. This allows a business to target customers approaching their facility where another advertising method could not. Customers can be detoured around billboards. And a communication means to the message being displayed allows a business to adjust the demand of or by anticipated customers. A business can do this within the demand cycle time of the product.

Further objects and advantages of my invention will become apparent from a consideration of the drawings and or ensuing description.

### 4. BRIEF DESCRIPTION OF THE DRAWINGS

FIG. 1 is a diagram showing the interconnecting flow of information used within the preferred invention.

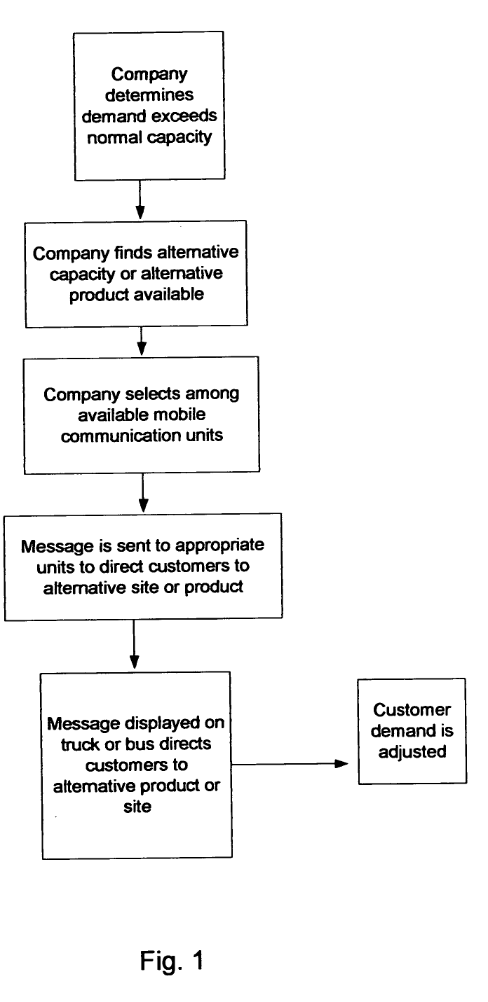

### 5. DETAILED DESCRIPTION OF THE PREFERRED EMBODIMENT

The preferred method of delivering this advertising message to the consumer from the business is in the form of an LCD or LED sign driven by a GPS enabled computer that could change the message on the sign. The sign should be at least 12 inches high and span the entire back section of a tractor trailer truck at the top of the doors. The GPS enables the computer to know both its present location and direction of travel of the sign. The database containing potential text and graphic messages for the sign in the computer is updated through a cell phone connection. The cell phone or pager connected to the sign computer calls a central server which can be updated by a business advertising on the truck sign by the business entering new information on the server for the truck sign to upload when it calls in. The new information when displayed on the mobile truck sign can direct a customer traveling in the direction of the business to either different products or different locations depending on particular profit incentives or productive capacity at the moment. In other manifestations the business could call an operator that could enter the server information for them or could call the truck directly with their modem. A low powered radio link could be broadcast from the truck to potential customers to give more details of intended products.

Many trucks may be in the system. This system is considered a communication system with the potential consumer. Each truck sign then is a mobile communication unit and yet part of a system. Each truck can be determined to be at a location when the onboard GPS indicates that it is at a location to the computer in communication with the changeable sign. Excess capacity or alternative products of a business is determined by the manager of the business or by rules or organization of the business. A business can communicate with the signs by a computer to a web page to a server and then to the computer on the truck and then the sign to the customer. A business might use a cell phone to communicate or a pager; any electronic means might be used to communicate. Various rule systems or algorithms can be used to determine direction of a vehicle when one location is known and then over time another location is known. The direction of travel of customers viewing the sign is known is the direction of travel of the truck sign is known.

Further objects and advantages of my invention will become apparent from a consideration of the drawings and or ensuing description. There are a number of issues in this invention that are interrelated with one another. Some of this has been discussed but should be restated. There is the issue of direction of travel of the display with the message on it relative to both a business and other vehicles. The content of the message is determined not only by its location but also by the direction of its travel whether toward a particular exit or business or away. The content of a message is determined by the local time of day whether it might be breakfast time or late at night. The content of a message is determined by the demand cycle of a product. This refers to a product or service that has a particular time span before it is needed again. An example is a hamburger can be desired every few hours but mostly at lunch while a new car is desired every few years or a soft drink could be desired every hour and an oil change every few months. The present invention is distinctly able to accommodate combinations of product demand cycles in conjunction with direction and time. The time duration a message is exhibited on a display and text size and length is dependent on the above and the relative speed of an observer. All of these considerations must be formed around anticipated potential customers that are determined by their location and direction of travel at a particular time of day. A customer traveling in the direction of a scheduled rock concert at a particular time of day is an anticipated potential customer for the concert while the same person at a different time of day or traveling in a different direction or location is not. The anticipated highway location where the message is displayed on a plurality of mobile display units must account for this as well as all the above. Only some of the LCD displays on some of the trucks in this example would be selected to carry a message and these units would direct traffic according to the multiple algorithms suggested above. The present invention is multifaceted and should not be limited without consideration of these factors.

When referring to a truck sign or liquid crystal sign this should not be interpreted to exclude signs such that might be changed by other means or operated by other means. Thus a light emitting diode sign on a truck that changed according to location and time and direction of travel would be covered in this patent. Direction of travel could be described both by a compass direction or relative direction to a known place or by computing a vector by sequential locations or by following an entity whose direction is known or by inertial reference to a known direction or any other method to determine direction from one point to another. Direction of travel must be determined before any message can be written. Direction of travel can be toward more than one business as businesses close to each other are in the same direction of travel on a road. Direction of travel can be used to anticipate customer demand by the fact that potential customers are traveling in the direction of a business. Side of vehicle refers to front, back, left or right side of a vehicle. Time and location can be divided into small parts or can have larger boundaries. Location refers to geographical location but general location can be a future location as yet determined an example being the general location of a thunder storm. The specific location of the storm center is unknown and any central absolute location is never known. Thus a general location in this case of the storm is specified. Location can also be at a moment in time as when the mobile sign passes through a location but does not stop. This moment is small and yet can be a part of the description of location of a moving target which the sign is. This moment of time should not be confused with time of day which is a measurement with beginning and end. But the location that is most often sold to a customer is an area and all the points within that area. Location in this case is an area measured from an idealized point that is probably defined by a certain distance from a fixed point such as an exit on a highway. A computer or processor or server is a machine that can along with their normal definition apply an algorithm or set of rules to data and act on the results. Information is communicated by cell phone or pager or electronically within the system in code or otherwise. A service with regard to the company selling advertising could be an advertisement or right to advertise message displayed or conveyed in any manner. A service with regard to a company buying advertising is anything a customer would pay for. A customer is anyone or entity that potentially may purchase something. Mobile media is any message delivering system that moves from location to location over time. A highway or roadway merely defines the place where the advertising message will be displayed. The direction of travel can be defined on the map such as North bound or by reference to another direction or by compass heading in the sale of the advertising. The content of a message is determined by the demand cycle of a product. This refers to a product or service that has a particular time span before it is needed again. An example is a hamburger can be desired every few hours but mostly at lunch while a new car is desired every few years or a soft drink could be desired every hour and an oil change every few months. The present invention is distinctly able to accommodate combinations of product demand cycles in conjunction with direction and time. Potential customers are entities that may do business at some future time with a company. An algorthim is any set of rules or step by step proceedure applied to information to achieve some end. A message is anything that conveys information and includes text as well as symbols or logos. Excess capacity is the productive ability to produce a surplus or more than demand for a product or service. A product or service is often what is sold by a business and the terms are often interchangeable. Banks use the term product for online bill paying when it could be considered a service. The preceding descriptions should not be considered limiting but rather to clarify and give example.

It is intended that further embodiments incorporating the spirit of the invention to one skilled in the art, fall within the scope of this invention.

I claim:

1. A method of adjusting customer demand, to capacity: said method comprising:
a. determining excess capacity;
d. selecting among mobile communication units by their location,
e. communicating a message to said mobile communication units
f. communicating said message to customers
whereby said message adjusts demand to capacity.

2. The method of claim 1 said claim further comprising: selecting among mobile communication units by their direction of travel.

3. The method of claim 1 said claim further comprising: where customers are potential customers.

4. The method of claim 1 wherein selecting among mobile communication units is by time of day.

5. The method of claim 1 said claim further comprising: communicating said message within the demand cycle of the product.

6. The method of claim 1 said claim further comprising: where determining is an algorithm.

7. The method of claim 1 said claim further comprising: whereby direction of travel anticipates customer demand.

8. The method of claim 1 said claim further comprising: where location is a general location.

9. An apparatus comprising:
a changeable sign mounted on a vehicle said sign in communication with a computer, said computer in communication with a GPS and said computer in communication with database of locations and messages to be displayed,
a roadway
a means for said business to communicate with said computer on vehicle,
a means of communication between changeable sign and customers.

10. The apparatus as in claim 9 said apparatus wherein the means for said business to communicate with computer is with a cell phone connection.

11. The apparatus as in claim 9 said apparatus further comprising: where the said changeable sign is within the possible sight of said customer.

12. The apparatus as in claim 9 wherein said customer is a potential customer.

13. The apparatus as in claim 9 wherein a changeable sign is a message.
